(19) United States
(12) Patent Application Publication
(10) Pub. No.: US 2007/0275603 A1
(43) Pub. Date: Nov. 29, 2007

(54) Electrical power apparatus with retractable cords and moveable sockets

(76) Inventors: Mina Hwang, Coral Springs, FL (US); Dan M. DeLaRosa, Coral Springs, FL (US)

Correspondence Address: Dan M. DeLa Rosa, Esq., Suite 24C, 300 East 77th Street, New York, NY, 10021, US

(21) Appl. No.: 11/805,349

(22) Filed: May 23, 2007

Related U.S. Application Data
(60) Provisional application No. 60/808,448, filed on May 26, 2006.

(51) Int. Cl. H01R 13/648

(52) U.S. Cl. 439/607

(57) ABSTRACT

An electrical power apparatus is provided, the apparatus comprises: a housing comprising a top portion, a bottom portion and side walls, the housing having at least one indentation situated at the top portion and a slot situated on the side wall; and at least one socket component connected to a retractable cord, the socket component being situated within the indentation of the housing at a first position perpendicular to the bottom portion of the housing and moveable to the slot of the housing at a second position parallel to the bottom portion of the housing, and at a third position wherein the cord is extended and there is a distance between the socket component and the housing.

### RELATED APPLICATION

This application is related to U.S. Provisional Patent Application Ser. No. 60/808,448, entitled “Electrical Power Apparatus with Retractable Cords and Moveable Sockets” which was filed on May 26, 2006.

### BACKGROUND OF THE INVENTION

1. Field of the Invention

This invention relates to an electrical power apparatus and more particularly, a surge protector having retractable cords and rotatable or moveable sockets. More specifically, the present invention relates to an electrical power apparatus comprising: a housing comprising a top portion, a bottom portion and side walls, the housing having at least one indentation situated at the top portion and a slot situated on the side wall; and at least one socket component connected to a retractable cord, the socket component being situated within the indentation of the housing at a first position perpendicular to the bottom portion of the housing and moveable to the slot of the housing at a second position parallel to the bottom portion of the housing, and at a third position wherein the cord is extended and there is a distance between the socket component and the housing.

2. Description of the Related Art

There are some surge protectors with retractable power cords in the prior art which utilizes a reel based mechanism. There are also wall mounted receptacles with retractable cords using cord reel assemblies. There are also surge protectors with a plurality of socket components attached to a plurality of cords which are connected to the housing of the surge protector.

Unlike the prior art, the present invention provides for an electrical power apparatus with moveable socket components capable of multiple angles in relation to the housing and further comprising socket components having retractable cords.

### SUMMARY OF THE INVENTION

In one embodiment, the present invention relates to an electrical power apparatus comprising: a housing comprising a top portion, a bottom portion and side walls, the housing having at least one indentation situated at the top portion and a slot situated on the side wall; and at least one socket component connected to a retractable cord, the socket component being situated within the indentation of the housing at a first position perpendicular to the bottom portion of the housing and moveable to the slot of the housing at a second position parallel to the bottom portion of the housing, and at a third position wherein the cord is extended and there is a distance between the socket component and the housing.

In another embodiment, the socket component comprises a head and a stem, and the stem is connected to the retractable cord. In yet another embodiment, the stem of the socket component is designed to sit within the slot allowing the head to be situated adjacent to the side wall of the housing. In still another embodiment, the top portion and bottom portion of the housing forms an internal cavity, and the indentation has an aperture, the cord is situated within the aperture and the internal cavity during a non-extended position.

In still yet another embodiment, the apparatus further comprises a surge protector and a power source, the surge protector is designed to protect electrical devices connected to the socket components from electrical surges from the power source.

In a further embodiment, the socket component comprises a means for retracting the cord. In yet a further embodiment, the apparatus further comprises an electrical power cord attached to the housing. In still a further embodiment, the electrical power cord is a retractable cord and comprises a means for retracting the electric power cord. In still yet a further embodiment, the apparatus further comprising a visual power signal source.

In another further embodiment, the present invention relates to an electrical power apparatus comprising: an elongated housing comprising a top portion, a bottom portion and at least one set of opposing side walls, the housing has at least one indentation situated at the top portion and at least two slots, each slot being situated adjacent to the indentation and situated on each of the opposing side wall; and at least one socket component connected to a retractable cord, the socket component being situated within the indentation of the housing at a first position perpendicular to the bottom portion of the housing and moveable to the first slot of the housing at a second position parallel to the bottom portion of the housing, the socket component is moveable to the second slot at a third position parallel to the bottom portion of the housing and at a fourth position wherein the cord is extended and there is a distance between the socket component and the housing.

In yet another further embodiment, the present invention provides for electrical power apparatus comprising: an elongated housing comprising a top surface portion and at least one set of opposing side walls; and a plurality of socket components, each of the socket component being situated on the top surface portion of the housing at a first position and moveable to a second position parallel at one side of the opposing sidewalls of the housing, each of the socket components being moveable to a third position to a second side of the opposing sidewalls of the housing. In this embodiment, the socket component is moveable about 180 degrees.

In still another further embodiment, at least one of the socket components comprises a retractable cord. In still yet another further embodiment, at least one of the socket components is moveable to a fourth position wherein the cord is extended creating a distance between the socket component and the housing.

In another embodiment, the apparatus further comprises a surge protector, a power source and electrical power cord, and the surge protector designed to protect electrical devices connected to the socket components from electrical surges from the power source.

In a further embodiment, the present invention further provides an electrical power apparatus comprising: a housing comprising a top portion and at least one side wall; and at least one socket component connected to a retractable cord, the socket component being situated at a first position on the top portion of the housing and moveable to a second position on the side wall of the housing, and at a third position wherein the cord is extended creating a distance between the socket component and the housing.

In the above mentioned embodiment, the socket component is moveable about 90 degrees. In another embodiment, the user may pull on the socket component thereby extending the cord to a certain length and then locks into place; when the user is done using the socket component, the user then again pulls or tugs on the socket component and the cord will then retract back into the housing.

In a further embodiment, the retractable cord attached to the socket component can use any means for retraction including, but not limited to, cord reels, cord pins, mechanisms utilized in retractable cords for vacuum cleaners, etc.

In another further embodiment, the side walls comprises a securing means such as pins, clips, etc. for securing the retractable cord of the socket component when the socket component is in an extended position.

In a further embodiment, the apparatus comprises tracks on which the retractable cords sit and ride during extension and retraction. These tracks are situated within the housing of the apparatus.

### BRIEF DESCRIPTION OF THE DRAWINGS

The accompanying drawings are included to provide a further understanding of the present invention. These drawings are incorporated in and constitute a part of this specification, illustrate one or more embodiments of the present invention, and together with the description, serve to explain the principles of the present invention.

FIG. 1 is an overhead view of one of the embodiments of the present invention;

FIG. 2 is a perspective view of one of the embodiments of the socket component of the present invention; and

FIG. 3 is an overhead view of another embodiment of the present invention showing an elongated housing.

Among those benefits and improvements that have been disclosed, other objects and advantages of this invention will become apparent from the following description taken in conjunction with the accompanying drawings. The drawings constitute a part of this specification and include exemplary embodiments of the present invention and illustrate various objects and features thereof.

### DETAILED DESCRIPTION OF THE INVENTION

As required, detailed embodiments of the present invention are disclosed herein; however, it is to be understood that the disclosed embodiments are merely exemplary of the invention that may be embodied in various forms. The figures are not necessary to scale, some features may be exaggerated to show details of particular components. Therefore, specific structural and functional details disclosed herein are not to be interpreted as limiting, but merely as a basis for the claims and as a representative basis for teaching one skilled in the art to variously employ the present invention.

FIG. 1 illustrates an overhead view of one of the embodiments of the electrical power apparatus 1 of the present invention. The electrical power apparatus 1 comprises: a housing 2 comprising a top portion 7 and at least one side wall 6; and at least one socket component 5 connected to a retractable cord 4, the socket component 5 being situated at a first position on the top portion 7 of the housing 2 and moveable to a second position on the side wall 6 of the housing 2, and at a third position wherein the cord 4 is extended creating a distance between the socket component 5 and the housing 2.

The socket component 5 is moveable about 90 degrees. The user may pull on the socket component 5 thereby extending the cord 4 to a certain length and then locks into place; when the user is done using the socket component 5, the user then again pulls or tugs on the socket component Sand the cord 4 will then retract back into the housing 2.

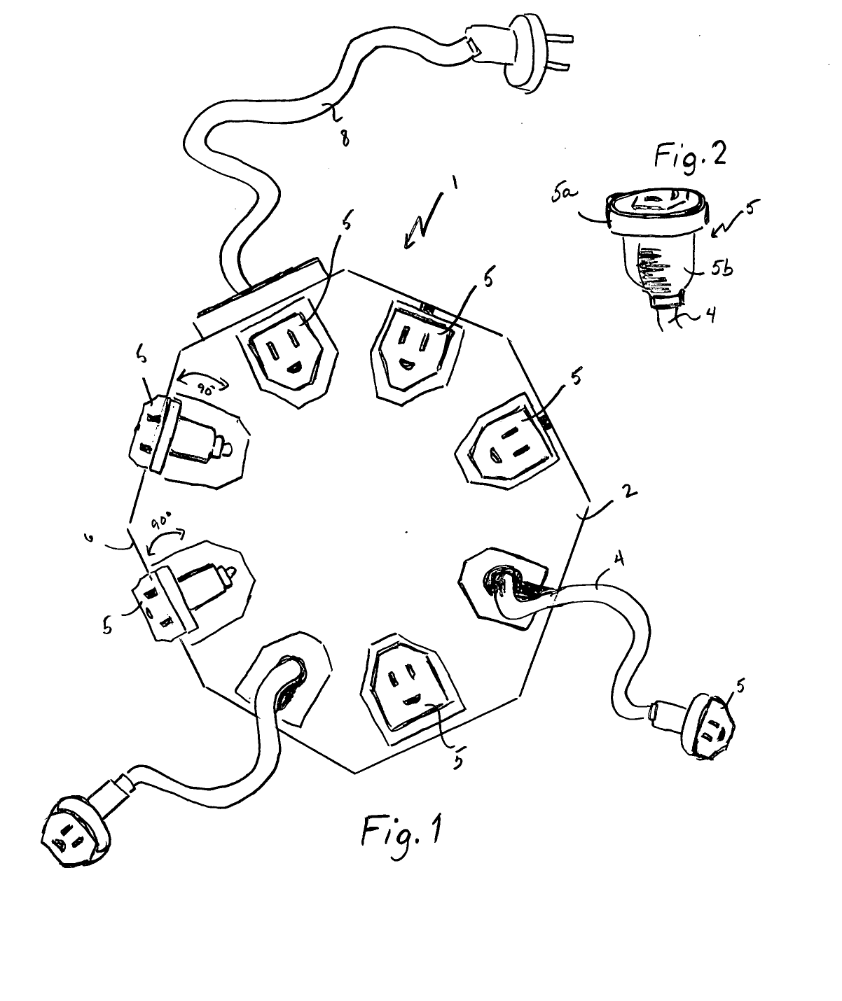

FIG. 2 shows one embodiment of the socket component 5; the socket component 5 comprises a head 5a and a stem 5b, and the stem 5b is connected to the retractable cord 4.

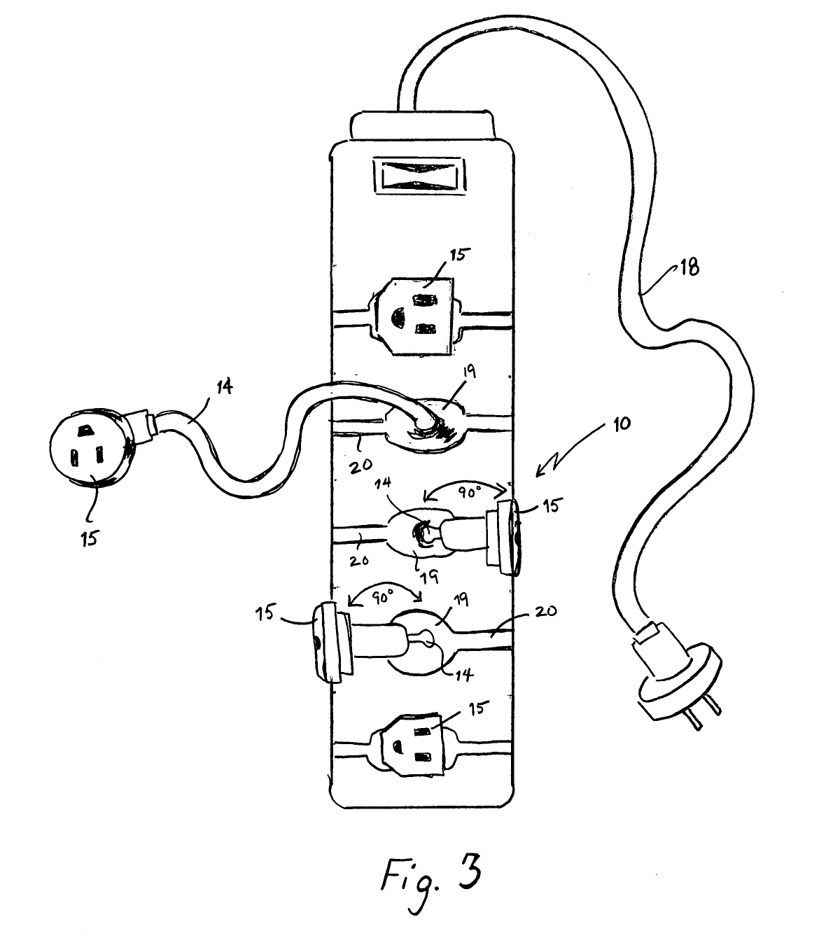

FIG. 3 illustrates another embodiment of the electrical power apparatus 10 of the present invention using an elongated housing 12. The electrical power apparatus 10 comprises: an elongated housing 12 comprising a top surface portion 17 and at least one set of opposing side walls 16a and 16b respectively; and a plurality of socket components 15, each of the socket components 15 being situated at a first position on the top surface portion 17 of the housing 12 and moveable to a second position on one side 16a of the opposing sidewalls of the housing 12, each of the socket components 15 being moveable to a third position to a second side 16b of the opposing sidewalls of the housing 12. In this embodiment, the socket components 15 are moveable about 180 degrees.

Numerous modifications and variations of the present invention are possible in light of the above teachings. It is therefore to be understood that within the scope of the attendant claims attached hereto, this invention may be practiced otherwise than as specifically disclosed herein.

What is claimed is:

1. An electrical power apparatus comprising:
a housing comprising a top portion and at least one side wall; and
at least one socket component connected to a retractable cord, said socket component being situated at a first position on the top portion of said housing and moveable to a second position on said side wall of said housing, and at a third position wherein said cord is extended creating a distance between said socket component and said housing.

2. The apparatus of claim 1 wherein said housing further comprises a bottom portion, at least one indentation situated at said top portion and a slot situated on said side wall, said socket component being situated within said indentation of said housing at a first position perpendicular to said bottom portion of said housing and moveable to said slot of said housing at a second position parallel to said bottom portion of said housing, and at a third position wherein said cord is extended and there is a distance between said socket component and said housing.

3. The apparatus of claim 2 wherein said socket component comprises a head and a stem, said stem being connected to said retractable cord, said stem of said socket component being designed to sit within said slot allowing said head to be situated adjacent to said side wall of said housing.

4. The apparatus of claim 1 wherein said top portion and bottom portion of said housing forms an internal cavity, said indentation having an aperture, said cord being situated within said aperture and said internal cavity during a non-extended position.

5. The apparatus of claim 1 further comprising a surge protector and a power source, said surge protector designed to protect electrical devices connected to said socket components from electrical surges from said power source.

6. The apparatus of claim 1 wherein said socket component comprises a means for retracting said cord.

7. The apparatus of claim 1 further comprising an electrical power cord attached to said housing.

8. The apparatus of claim 7 wherein said electrical power cord is a retractable cord and comprises a means for retracting said electric power cord.

9. The apparatus of claim 1 further comprising a visual power signal source.

10. An electrical power apparatus comprising:
an elongated housing comprising a top portion, a bottom portion and at least one set of opposing side walls, said housing having at least one indentation situated at said top portion and at least two slots, each slot being situated adjacent to said indentation and situated on each of said opposing said side wall; and
at least one socket component connected to a retractable cord, said socket component being situated within said indentation of said housing at a first position perpendicular to said bottom portion of said housing and moveable to said first slot of said housing at a second position parallel to said bottom portion of said housing, said socket component is moveable to said second slot at a third position parallel to said bottom portion of said housing and at a fourth position wherein said cord is extended and there is a distance between said socket component and said housing.

11. The apparatus of claim 10 wherein said socket component comprises a head and a stem, said stem being connected to said retractable cord.

12. The apparatus of claim 11 wherein said stem of said socket component being designed to sit within said slot allowing said head to be situated adjacent to said side wall of said housing.

13. The apparatus of claim 11 wherein said socket component comprises a means for retracting said cord.

14. The apparatus of claim 11 further comprising a surge protector, a power source and electrical power cord, said surge protector designed to protect electrical devices connected to said socket components from electrical surges from said power source.

15. The apparatus of claim 14 wherein electrical power cord is a retractable cord and comprises a means for retracting said electric power cord.

16. The apparatus of claim 11 further comprising a visual power signal source.

17. An electrical power apparatus comprising:
an elongated housing comprising a top surface portion and at least one set of opposing side walls; and
a plurality of socket components, each of said socket component being situated at a first position on said top surface portion of said housing and moveable to a second position on one side of said opposing sidewalls of said housing, each of said socket components being moveable to a third position to a second side of said opposing sidewalls of said housing.

18. The apparatus of claim 17 wherein at least one of said socket components comprises a retractable cord.

19. The apparatus of claim 18 wherein at least one of said socket components is moveable to a fourth position wherein said cord is extended creating a distance between said socket component and said housing.

20. The apparatus of claim 17 further comprising a surge protector, a power source and electrical power cord, said surge protector designed to protect electrical devices connected to said socket components from electrical surges from said power source.
